(19) United States
(12) Patent Application Publication
(10) Pub. No.: US 2013/0229964 A1
(43) Pub. Date: Sep. 5, 2013

(54) METHOD AND APPARATUS FOR MAINTAINING A POWER SAVING STATE AT A NETWORK DEVICE

(71) Applicant: QUALCOMM INCORPORATED, San Diego, CA (US)

(72) Inventors: Chetan G. CHAKRAVARTHY, San Diego, CA (US); Arvindhan KUMAR, San Diego, CA (US); Subbarayudu MUTYA, Hyderabad, IN (US); Yongsheng SHI, San Diego, CA (US); Liangchi HSU, San Diego, CA (US); Venkata A. Naidu BABBADI, Hyderabad, IN (US)

(73) Assignee: QUALCOMM Incorporated, San Diego, CA (US)

(21) Appl. No.: 13/759,698

(22) Filed: Feb. 5, 2013

Related U.S. Application Data
(60) Provisional application No. 61/605,464, filed on Mar. 1, 2012.
(60) Provisional application No. 61/611,476, filed on Mar. 15, 2012.

(51) Int. Cl. H04W 52/02

(52) U.S. Cl. CPC H04W 52/02
USPC 370/311

(57) ABSTRACT

The described aspects include a user equipment (UE) apparatus, network component, and corresponding methods of communicating power saving information using common uplink messages. By using a resource update message to communicate power saving information from a UE, the UE need not request and establish resources with the network for requesting a power state that uses less power than a current state. Similarly, in UE mobility, the UE can indicate previous power saving information to a target Node B to cause the target Node B to refrain from assigning resources to the UE.

### CLAIM OF PRIORITY UNDER 35 U.S.C. §119

The present application for patent claims priority to U.S. Provisional Application No. 61/605,464 entitled “METHOD AND APPARATUS FOR MAINTAINING A POWER SAVING STATE AT A NETWORK DEVICE” filed Mar. 1, 2012, and U.S. Provisional Application No. 61/611,476 entitled “METHODS AND APPARATUSES FOR OPTIMIZED UMTS FAST DORMANCY” filed Mar. 15, 2012, and assigned to the assignee hereof and hereby expressly incorporated by reference herein.

### BACKGROUND

1. Field

Aspects of the present disclosure relate generally to wireless communication systems, and more particularly to power state management for network devices.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division—Code Division Multiple Access (TD-CDMA), and Time Division—Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

Moreover, the recent growth of smartphones as a data centric market and availability of applications to cater the needs of a diversified community has made the devices power hungry. ‘Battery Drain’ has become a commonly disclosed issue among smartphone users and the community has attempted to adapt itself to deal with this ongoing issue. Such power issues can mostly be attributed to a bad network configuration that pushes a device to a power draining state or a mobile device's inability to communicate efficiently to the network its need for a better power saving state.

Generally, a wireless multiple-access communication system can simultaneously support communication for multiple user equipment devices (UEs). Each UE communicates with one or more base stations, such as a Node B via transmissions on the forward and reverse links. The forward link (or downlink) refers to the communication link from the Node Bs to the UEs, and the reverse link (or uplink) refers to the communication link from the UEs to the Node Bs. This communication link may be established via a single-in-single-out, multiple-in-single-out or a multiple-in-multiple-out (MIMO) system.

In third generation partnership project (3GPP) based UMTS networks, a UE device is transitioned across different Radio Resource Control (RRC) states from the moment a data path is established. Handsets or UEs are usually maintained in high data rate channels to ease the flow of data as when the handset arrives within a network or Node B region. This contributes to the power drain significantly considering the bursty nature of data transfer. Additionally, the higher layer signaling overhead required to push a UE device to different RRC states that are able to consume relatively less power and to an Idle state that consumes even less power takes not only time but also expends a considerable amount of battery power. Moreover, the timers and controls for switching between these states are largely held by the network and must be sent to the UE, which may further drain the battery.

Several asynchronous mechanisms were proposed and used by mobile vendors to gain a better power saving state without explicit signaling communication. These asynchronous mechanisms not only puts the network in a disconnect mode but also increases the subsequent set of unwarranted signaling between the UE and the network. In some examples, UEs can maintain data connections with Node Bs for communicating data therewith. Mechanisms are provided, however, for allowing a UE to request signaling release from a Node B to conserve power by reducing a required signaling load associated with an active data connection. The UE can then determine, for example, that releasing a radio resource connection with the Node B can result in power savings to the UE (e.g., where the UE has little or no data activity).

In UMTS, for example, such a request can include a signaling connection release indication (SCRI) with a specified cause indicating “UE Requested Packet Switched (PS) Data Session End.” This allows for a concept known as fast dormancy (FD), where the UE indicates to the network to release radio resources held by the UE. In this example, the network, in response to the indication, can command the UE to release resources at a radio resource control (RRC) layer. This allows the UE to operate in a power saving state (e.g., to receive paging signals in given time intervals). Specifically, for example, upon receiving the SCRI, the network can signal the UE to release the radio resources, and/or to transition to a more efficient state, such as IDLE, cell paging channel (CELL_PCH), UTRAN registration area (URA) paging channel (URA_PCH), cell forward access channel (CELL_FACH), etc.

In some examples, however, the wireless network can configure timers for controlling when the UE can request transition to a power limited state. Moreover, if the UE is in a power limited state, the UE must request transition to a CELL_FACH state (e.g., by sending a CELL_UPDATE message) before communicating with the network. This also applies to communications for signaling the SCRI with FD cause to the network for requesting a power state utilizing less power (e.g., IDLE state where the UE is currently in a CELL_PCH or URA_PCH state). Transitioning to the CELL_FACH state requires additional configuration and resource utilization by the UE, which contributes to additional UE power consumption and additional network resources.

Thus, methods and apparatuses are desired for improving signaling between the UE and the network resulting in efficient power state management for network devices.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Various considerations regarding indicating power saving state information in common uplink control messages to mitigate additional overhead typically associated with separate power saving state information messages, and other considerations are addressed herein.

In one aspect, a method for communicating power saving information in a wireless network is provided. The method includes determining to communicate power saving information to a network component based in part on determined data inactivity and signaling the power saving information to the network component in a resource update message.

Additionally, an apparatus for communicating power saving information in a wireless network is provided. The apparatus includes a processor configured to determine to communicate power saving information to a network component based in part on determined data inactivity and signal the power saving information to the network component in a resource update message.

Still further, the apparatus includes means for determining to communicate power saving information to a network component based in part on determined data inactivity and means for signaling the power saving information to the network component in a resource update message

In another aspect, a computer program product having a computer-readable medium for communicating power saving information in a wireless network is provided. The computer-readable medium may include machine-executable code for determining to communicate power saving information to a network component based in part on determined data inactivity and machine-executable code for signaling the power saving information to the network component in a resource update message.

These and other aspects of the disclosure will become more fully understood upon a review of the detailed description, which follows.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a schematic block diagram of one aspect of a system for communicating power saving information;

FIG. 2 is a schematic block diagram of one aspect of a system for signaling power saving information in a resource update message;

FIG. 3 is a flowchart of one aspect of a method of the systems of FIGS. 1 and 2;

FIG. 4 is a flowchart of one aspect of a method of the systems of FIGS. 1 and 2;

FIG. 5 is a flowchart of one aspect of a method of the systems of FIGS. 1 and 2;

FIG. 6 is a schematic block diagram of one aspect of a system for communicating power saving information;

FIG. 7 is a schematic block diagram of one aspect of a system for determining a power saving state;

FIG. 8 is a block diagram illustrating additional example components of an aspect of a computer device having a call processing component according to the present disclosure;

FIG. 9 is a block diagram illustrating an example of a hardware implementation for apparatuses of FIGS. 1 and 2 employing a processing system;

FIG. 10 is a block diagram conceptually illustrating an example of a telecommunications system including aspects of the systems of FIGS. 1 and 2;

FIG. 11 is a conceptual diagram illustrating an example of an access network including aspects of the systems of FIGS. 1 and 2;

FIG. 12 is a conceptual diagram illustrating an example of a radio protocol architecture for the user and control plane implemented by components of the systems of FIGS. 1 and 2;

FIG. 13 is a block diagram conceptually illustrating an example of a Node B in communication with a UE in a telecommunications system, including aspects of the systems of FIGS. 1 and 2.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

As described above, features aimed at saving both user battery power and also signaling overheard from network's perspective were proposed by 3GPP and other standards organization. These features have tried to provide a bilateral communication between the core network and the user to negotiate a better power saving state. At times, the mobile devices have a better understanding of the current state and can provide a better request or rather a feedback to the network in terms of power savings. On the other hand, the network pre-configured timers for inactivity, which transition the mobile device to lower power consumption state, may not be tuned to consider all possible cases. In such cases, having the core network accept feedback from mobile devices may become be mutually beneficial for both the core network and the mobile device. Note, these power saving features should be carefully designed to make sure that they do not add to the signaling overhead and impede the overall objective.

In the 3GPP community, FD is one such feature that gives the mobile devices the capability to signal the network an SCRI message with a special cause in all RRC states and request for a better power saving state. By signaling a timer T323 in the network's system information, the mobile device indirectly notifies a network that the mobile device supports this FD feature with a special cause, and puts a check on flooding of SCRI requests from various applications. Thus, a UTRAN, on reception of a SCRI with special cause for FD, may initiate a state transition to an efficient battery consumption RRC state that include a IDLE, CELL_PCH, URA_PCH, or CELL_FACH.

According to 3GPP specification 25.331, section 8.1.14.2: if the timer T323 value is stored in the information element (IE) “UE Timers and constants in connected mode” in the variable TIMERS_AND_CONSTANTS, and if there is no circuit switched (CS) domain connection indicated in the variable ESTABLISHED SIGNALING CONNECTIONS, the UE is configured to execute the following:
1> if the upper layers indicate that there is no more PS data for a prolonged period:
   2> if timer T323 is not running:
      3> if the UE is in cell dedicated channel (CELL_DCH) state or cell forward access channel (CELL_FACH) state; or
      3> if the UE is in cell paging channel (CELL_PCH) state or UTRAN registration area paging channel (URA_PCH) state and the discontinuous receive (DRX) cycle length in use is shorter than the shorter core network (CN) domain specific DRX cycle length for the PS domain and CS domain; or
      3> if the UE is in CELL_PCH state or URA_PCH state and the DRX cycle length in use is equal to or longer than the shorter CN domain specific DRX cycle length for the PS domain and CS domain, and V316<1:
         4> if the UE is in CELL_PCH state or URA_PCH state and the DRX cycle length in use is equal to or longer than the shorter CN domain specific DRX cycle length for the PS domain and CS domain:
         5> increment V316 by 1, where V316 indicates how many times SCRI can be transmitted in a given state.
         4> set the information element (IE) “CN Domain Identity” to PS domain;
         4> set the IE “Signalling Connection Release Indication Cause” to “UE Requested PS Data session end”;
         4> transmit a SIGNALLING CONNECTION RELEASE INDICATION message on DCCH using AM RLC;
         4> start the timer T323;
      3> the procedure ends.

However, in case the UTRAN decides to transition the mobile device to CELL_PCH or URA_PCH state as a measure to help conserve some battery power, the UE monitors only the paging channels on regular DRX cycle wake up occasions and performs searches to indicate any mobility. In other words, the mobile device in CELL_PCH or URA_PCH state will perform URA or CELL update when the mobile device changes from one cell (or URA) to another. In this case, the device wakes up to do so less frequently than in other state.

Indeed, any transmission on uplink by the device for data or signaling requirement requires the device to transition to a CELL_FACH state and transmit a CELL_UPDATE message. For instance, if a SCRI for FD is initiated in a CELL_PCH or a URA_PCH state considering the configured DRX cycle lengths, the UE has to first transition to a CELL_FACH and use random access channel (RACH) resources for transmission of a CELL UPDATE message first. In response, the core network may configure the RACH and secondary common control physical channel (SCCPCH) resources in FACH to facilitate the SCRI transmission from the device or UE. Additional signaling overhead associated with FDSCRI usage in PCH RRC states contributes to battery drain considering the bursty nature of data transfer and number of such transitions to a CELL_FACH.

As a mobile device is maintained in a CELL_FACH state where there is no more power savings data for a prolonged period of time (data inactivity) and previous FD SCRI requests, the mobile device evaluates the neighboring cells for cell reselection. The new or neighboring cells that the mobile reselects might have different DRX cycle length configurations and have no idea of the power saving state of the mobile device. In such cases the mobile device is expected to signal another SCRI in the new cell for the network to respond and transition the mobile device to a battery efficient state for the new cell.

Thus, aspects of the proposed 3GPP FD feature is one example of a power saving feature that can be better optimized to avoid the above explained additional signaling overhead by carefully designing the available signaling information elements.

Described herein are various aspects related to indicating power saving state information in common uplink control messages, such as a resource update message. For example, a UE can determine a power saving state, and can indicate the state or related information in messages typically used to request transitioning to an active communication state, such as a CELL_UPDATE or UMTS Terrestrial Radio Access Network (UTRAN) registration area (URA)_UPDATE message. Thus, a UE operating in a power saving mode can request transitioning to a different power saving mode without first transitioning to an active communication mode to transmit the request. For example, a UE in a cell paging channel (CELL_PCH) mode can request transition to an IDLE state by specifying power saving state information in a CELL_UPDATE message transmitted to the network. In one example, the network can receive the message and can transition the UE to the IDLE state without providing resource assignment thereto.

Similarly, a UE reselecting from a source Node B to a target Node B can transmit the CELL_UPDATE message with power saving state information, where the UE is in a power saving state at the source Node B before reselection. Thus, the target Node B can transition or otherwise maintain the power saving state of the UE without requiring the UE to establish resources for communicating power saving state information thereto. In either case, this reduces signaling requirements for the UE, which results in reduced network signaling and reduced power consumption at the UE.

In short, aspects of this apparatus and method describe a power saving feature which may be designed for a UE that may be optimized by including necessary state information as additional information elements in the message transmitted to the core network. This information can be conveyed also in cases of mobility to the newly selected cells and thereby the core network can maintain continuity of the best power saving state.

Thus, aspects of the present apparatus and methods relate improving signaling between the UE and the network resulting in efficient power state management for network devices.

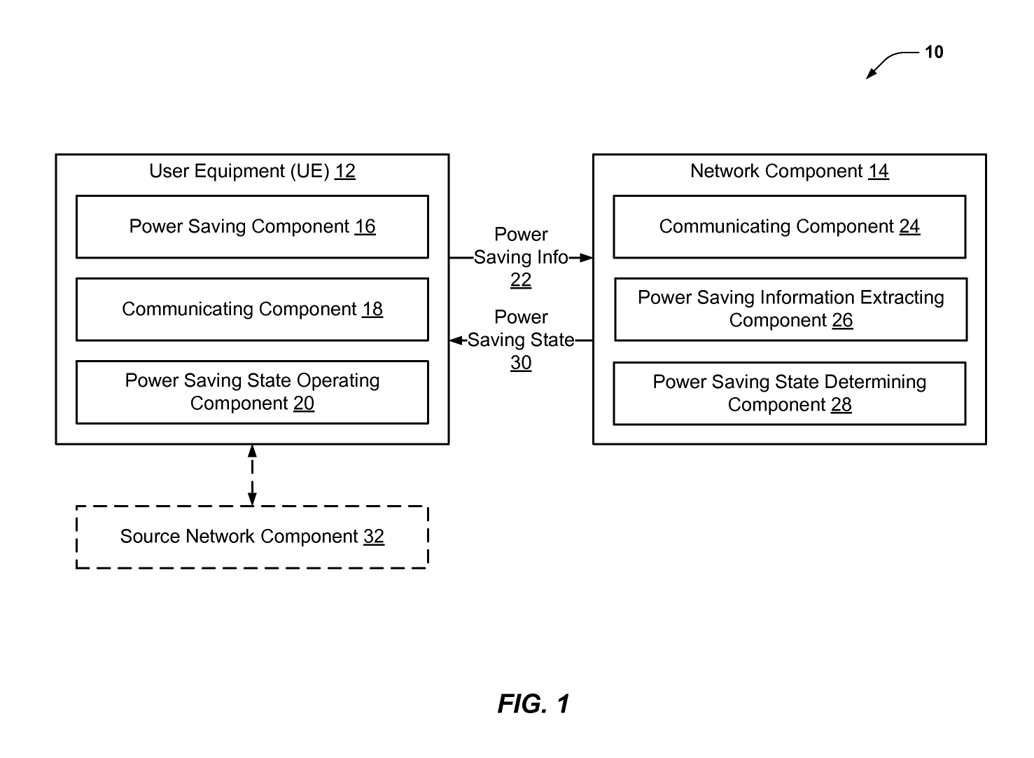

Referring to FIG. 1, in one aspect, a wireless communication system 10 includes a user equipment (UE) 12 for communicating with a network component 14 to receive wireless network access. For example, the network component 14 can be substantially any component of a core wireless network, such as a Node B (e.g., a macrocell, picocell, or femtocell Node B) or a component with which UE 12 can communicate via a Node B, such as a Radio Network Controller (RNC), one or more support nodes (e.g., Serving GPRS Support Node (SGSN), Gateway GPRS Support Node (GGSN)), a Mobile services Switching Centre (MSC), Visitor Location Register (VLR), Home Location Register (HLR), and/or the like. The network component 14 can include functionality for managing power states of UE 12.

UE 12 includes a power saving component 16 for determining power saving information related to UE 12, a communicating component 18 for transmitting and receiving signals to network components in a wireless network, and a power saving state operating component 20 for operating UE 12 in a given power saving state. Communicating component 18 can communicate power saving state information 22 to a network component, in one example.

Network component 14 includes a communicating component 24 for communicating with UEs in a wireless network, a power saving information extracting component 26 for determining power saving information for a UE, and a power saving state determining component 28 for selecting a power saving state for the UE based on the power saving information. Communicating component 24 can communicate a power saving state 30 to UE 12, for example.

According to an example, UE 12 can communicate with network component 14 to receive wireless network access. UE 12 can operate in various communication states, as described; UMTS examples of such states include IDLE, CELL_PCH, URA_PCH, CELL_FACH, cell dedicated channel (CELL_DCH), etc. In some states, such as CELL_DCH, UE 12 is assigned resources for regularly communicating with network component 14. In some cases, however, such resource utilization is not required by the UE 12, and the UE 12 can thus benefit from operating in a state with a less amount of resource utilization. For example, in an CELL_PCH state, the UE 12 can receive paging signals from network component 14 over defined paging intervals, and can power down communication hardware (e.g., communicating component 18) during the intervals. Network component 14 can maintain the communication state of UE 12.

As described, power saving component 16 can generate power saving information 22 for transmitting to network component 14, such as a signaling connection release indication (SCRI), indication of a desired power saving state, etc. In one example, power saving component 16 generates the power saving information 22 based on detecting that UE 12 has little or no data to send to network component 14. Indeed, the power saving component 16 generates the power saving information 22 based on detecting data the UE 12 has to send to the network is less than a predetermined threshold (e.g., less than a predetermined number of bytes defined by the powers savings application being utilized by the UE 12). Moreover, for example, power saving component 16 can generate the power saving information 22 to transition to a power saving state based in part on a comparison of a current state within which the UE 12 operates with the power saving state.

This comparison can also include, for example, determining requirements for communication at the UE 12 and whether the power saving state would meet these requirements. For example, if the UE 12 has low priority data to send, and a power saving state allows sending within a threshold period of time, the UE 12 can indicate a desired transition to the power saving state in power saving information 22 (or can otherwise indicate the data requirements, and the network component 14 can decide on the power saving state for UE 12, as described further herein).

In any case, communicating component 24 can receive the power saving information 22, and power saving information extracting component 26 can determine the power saving information 22 from one or more messages carrying the information 22. The power saving information 22, as described, can include an indication to release radio resources, one or more states within which the UE 12 desires to operate, information from which a state decision can be made (e.g., data to be transmitted in a given period of time at UE 12), etc. As described further herein, the network component 14 can accordingly terminate the data connection, effectuate a state transition at the UE 12, and/or determine a state for UE 12 operation, where the information 22 requests such.

In one example, power saving state determining component 28 can also select a power saving state 30 for UE 12 to minimize resources used by the UE 12 considering the data connection is terminated. Communicating component 24 can transmit the power saving state 30 to UE 12. Power saving state operating component 20 can operate in the power saving state 30, for example. In one specific example, communicating component 18 can send a SCRI with a cause indicating more information regarding terminating the data connection. In a specific example, the cause can include “UE Requested Packet Switched (PS) Data Session End,” or a similar cause that facilitates Fast Dormancy (FD) functionality in UMTS. Network component 14 accordingly commands the UE 12 to release radio resources held by the UE 12 for communicating with the network component 14, and/or power saving state determining component 28 accordingly determines the power saving state 30 for UE 12, based on the specified cause.

For example, where UE 12 is operating in a power saving state, such as CELL_PCH or URA_PCH in UMTS, power saving component 16 can determine to request transitioning to a more efficient power saving state, such as IDLE in UMTS. In this example, rather than UE 12 first transitioning to CELL_FACH to send the power saving information 22 to network component, power saving component 16 can include the power saving information 22, or a representation thereof, in a common uplink message, such as resource update messages or other messages normally used for requesting communication resources, transitioning to a more active state for communicating with network component 14 (e.g., a CELL_UPDATE or URA_UPDATE for requesting transition to a CELL_FACH state in UMTS), and/or the like.

In this example, communicating component 24 can receive the common uplink message, and power saving information extracting component 26 can determine whether the common uplink message includes power saving information. For example, power saving information extracting component 26 can determine such based on one or more information elements (IE) in the common uplink message (e.g., whether the message includes a IE related to power saving information). If so, power saving information extracting component 26 can obtain the power saving information 22 from the common uplink message. In one example, the power saving information 22 can include information related to a SCRI or related cause to release resources (e.g., in a power saving IE), and network component 14 can accordingly command the UE 12 to release radio resources (e.g., via a RRCConnectionRelease or similar message).

Moreover, in an example, network component 14 can modify typical behavior associated with the common uplink message based on the power saving information 22 within the message. For example, where a CELL_UPDATE message is received with power saving information 22, network component 14 can refrain from granting resources to UE 12 typically associated with a CELL_UPDATE message. In addition, power saving state determining component 28 can select a power saving state for UE 12 based on the power saving information 22. In an example, where UE 12 is in a CELL_PCH mode and the power saving information 22 includes an SCRI or other indication to release radio resources or that resources are otherwise not currently needed at the UE 12, power saving state determining component 28 can select another power saving state for operating UE 12, such as an IDLE state. In any case, communicating component 24 communicates an indication of the power saving state 30 to UE 12, and power saving state operating component 20 operates the UE according to the power saving state 30. In another example, the power saving information 22 can include the desired state, and power saving state determining component 28 can determine whether the state is appropriate or otherwise possible (e.g., based on timers or other verification related to UE 12).

In another example, UE 12 can perform mobility (also referred to herein as handover) from a source network component 32 to network component 14. In this example, UE 12 can have previously transmitted power saving information (e.g., a SCRI) to source network component 32, and communicated therewith in a reduced power state, such as CELL_PCH, IDLE, etc. UE 12 can reselect from source network component 32 to network component 14. This can be based on reporting improved signal metrics with respect to network component 14 over source network component 32, etc. As part of the mobility procedure with network component 14, power saving component 16 can communicate the power saving information 22, previously communicated to source network component 32, to network component 14. Thus, communicating component 24 can receive the power saving information 22 as part of the mobility procedure (e.g., in a CELL_UPDATE message in UMTS), and power saving information extracting component 26 can obtain the power saving information 22 from the message. Based on the message, for example, network component 14 can determine to forego resource assignment (e.g., at a RRC layer) to UE 12 for the time being based on the power saving information 22. In addition, in one example, power saving state determining component 28 can select a state for operating the UE 12, and communicating component 24 can indicate the state to UE 12 as part of the mobility procedure (e.g., in an acknowledgement or other response to the CELL_UPDATE message).

Note, while the UE is reselecting across different cells that might belong to different radio network controller (RNC)'s, it may be beneficial if the UE includes information regarding the current battery saving state. When reselecting to a new cell, the UE, in either CELL FACH or PCH state, may transmit a CELL UPDATE message with cause CELL RESELECTION to notify the UE's arrival to the network.

In other words, described above is a proposal for introducing an additional Information Element (“UE Requested PS Data session end”) to be signaled in the CELL UPDATE or URA UPDATE message, with which a UE may request a battery efficient RRC state due to known data inactivity to the core network. This new additional information element assists the UE in a CELL_PCH or a URA PCH RRC state in requesting for an improved power state given that the DRX cycle lengths for these states may be longer than the DRX cycle in an IDLE state. Moreover, since a UE in PCH states lack the ability to transmit any uplink data directly, the UE is required to first transmit a CELL UPDATE L3 message requesting transition to a CELL FACH state.

Therefore, if the UE is able to include a request for better power saving state through the proposed additional IE in the CELL UPDATE message itself, additional overhead of signaling from the core network is reduced. Thereby configuring the UE with RACH/FACH resource to transmit SCRI with a “UE Requested PS Data session end” and later move the UE to an IDLE state. In response to the CELL UPDATE message with the proposed additional IE, the network may then directly send a RRC CONNECTION RELEASE message to transition the UE to an IDLE state.

Additionally, across the entire cell DRX cycle, the values used for each individual DRX cycle might be different and mobile devices already in a power saving state can inform the network of this fact by including the proposed additional information element “UE Requested PS Data session end” in CELL UPDATE message itself Based on this feedback from the mobile device, the network can decide to transition the user to a better power saving state or maintain in the same power saving state. Inclusion of this new additional IE need not be bound by T323 timer configured by the network as its not additional signalling as such but using the existing uplink L3 message with an extra IE.

Additionally, for a non-FD SCRI message, with the IE “Signalling Connection Release Indication Cause” set to “any other cause” or not included, the above optimization can also be applied. A new cause (may be domain specific) in the Cell Update message can notify the network about the UE's intention to remove the signalling connection. Thus the network may reply with RRC Connection Release to release the RRC connection or take other actions.

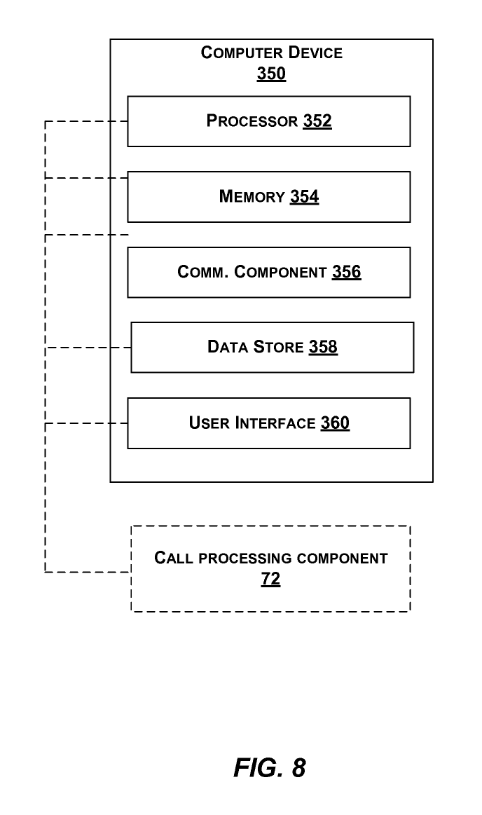

As such, wireless communication system 10 of FIG. 1 may comprise power saving component 16, communicating component 18, power savings sate operating component 20, communicating component 24, power saving information extracting component 26, and power saving state determining component 28. These components and storage may be implemented, for example, by hardware components specifically configured to carry out the stated processes/algorithm, implemented by a processor configured to perform the stated processes/algorithm, stored within a computer-readable medium for implementation by a processor, or some combination thereof will be discussed in more detail with regards to FIGS. 8-13.

Thus, methods and apparatuses are desired for improving signaling between the UE and the network resulting in efficient power state management for network devices.

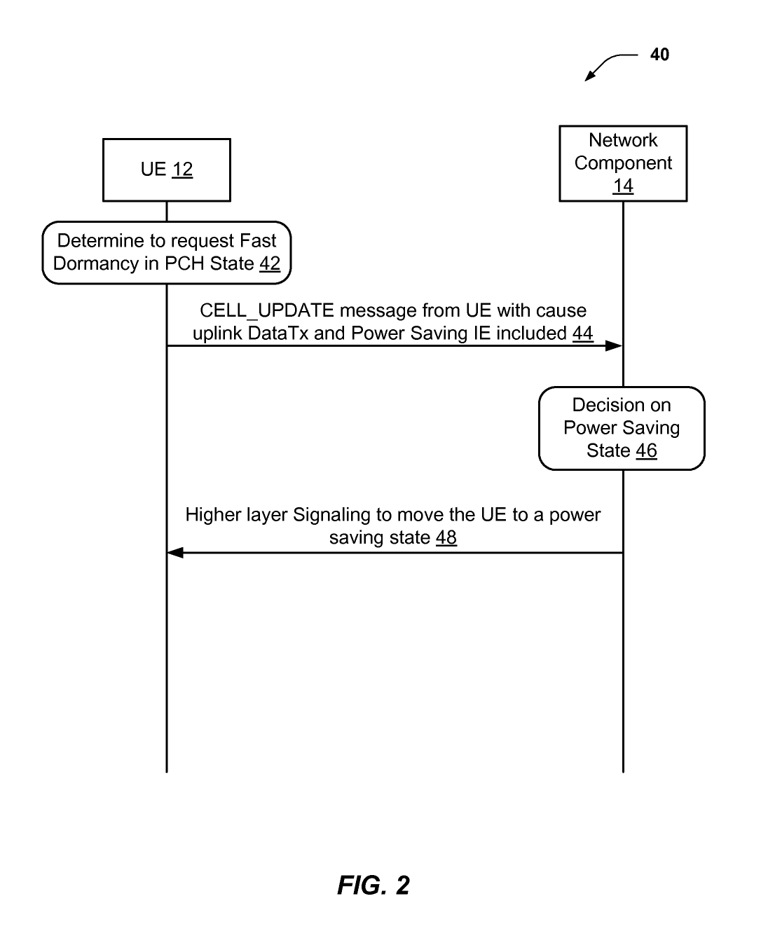

Turning to FIG. 2, in one aspect, a system 40 is depicted for communicating power saving information in a wireless network. System 40 includes a UE 12 that communicates with a network component 14, as described, operating in one or more communication states to manage power utilization. UE 12 (e.g., power savings component 16, FIG. 1) determines to request FD in PCH state 42, as described. Since UE 12 is in a PCH state, it lacks the ability to transmit uplink data directly without first transmitting a CELL_UPDATE requesting transition to a CELL_FACH or other more active communication state. In this example, however, UE 12 (e.g., communicating component 18, FIG. 1) can transmit the CELL_UPDATE message with cause “Uplink Data Transmission” and the power saving IE included 44. Thus, the UE 12 need not separately signal the power saving information.

In this example, network component 14 receives the message 44 and obtains the power saving IE. In this regard, network component 14 need not assign radio resources to UE 12 since the UE 12 indicates by information in the power saving IE that it does not need an open data connection at this time. In addition, network component 14 (e.g., power saving state determining component 28, FIG. 1) can make a decision on a power saving state 46 for UE 12. This can be based on the power saving IE information, as described, such that network component 14, in one example, can select a state that uses less power than a current state operated by UE 12. Network component 14 (e.g., communicating component 24, FIG. 1) can then transmit higher layer signaling to move the UE to the power saving state 48. Thus, no resources are granted to UE 12, and signaling is conserved, which can improve power efficiency of UE 12.

As such, the system 40 of FIG. 2 may be configured to improve signaling between the UE and the network resulting in efficient power state management for network devices as described in FIG. 1.

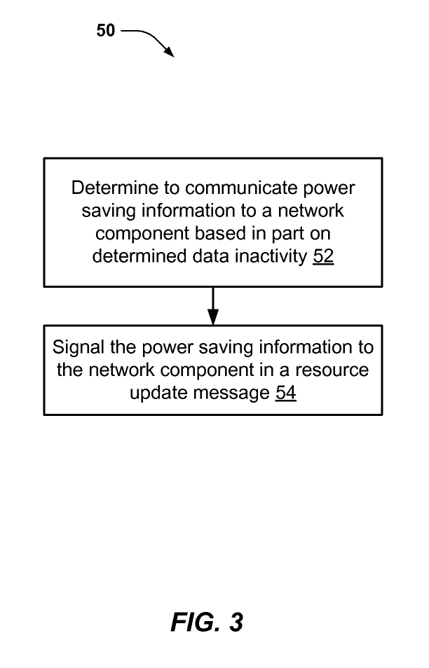

Referring to FIG. 3, in one aspect, illustrated is a method 50 for communicating power saving information in a wireless network.

At 52, it can be determined to communicate power saving information to a network component based in part on determined data inactivity. For example, power saving component 16 residing in UE 12 is configured to determine power saving information 22 related to UE 12 that may be communicated to network component 14 by communicating component 18 residing in UE 12 (FIG. 1). In other words, it can be determined that there is little or no data to send (or that such is the case for a determined period of time). Thus, a state that uses less resources for communicating with the network component may be desirable. The power saving information can include a request to transition to a state requiring less power, a request to terminate a data connection, and/or the like.

At 54, the power saving information can be signaled to the network component in a resource update message. For example, power saving information 22 may be signaled to network component 14 from UE 12 in a resource update message (FIG. 1). As described, this can include communicating the resource update message as an IE in a resource update message, such as CELL_UPDATE, URA_UPDATE, etc., in UMTS.

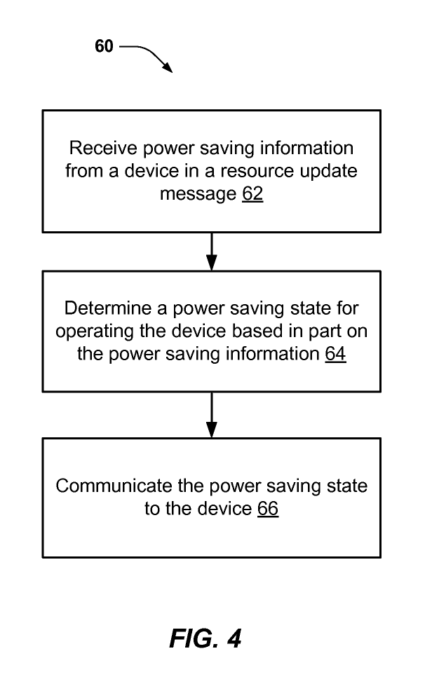

FIG. 4, in one aspect, illustrates a method 60 for communicating power saving information in a wireless network.

At 62, power saving information can be received from a device in a resource update message. For example, power saving information 22 may be received at the network component 14 (e.g., communicating component 24) from UE 12 in a resource update message (FIG. 1). As described, this can include an IE in a resource update message, such as a CELL_UPDATE or URA_UPDATE message in UMTS. The power saving information can include a SCRI, a request to transition to a state requiring less power utilization, and/or the like.

At 64, a power saving state for operating the device can be determined based in part on the power saving information. Indeed, this can be a power state requiring less power than a current power state of the device where the information so indicates. For example, power saving state 30 for operating UE 12 may be determined by the power saving state determining component 28 residing in network component 14 and based on the power saving information 22 received at the network component 14 (FIG. 1).

At 66, the power saving state can be communicated to the device. This can include transmitting the power saving state to the device in higher layer signaling, and can cause the device to move into the power saving state. For example, power saving state 30 may be communicated to UE 12 by the communicating component 24 residing in network component 14 (FIG. 1).

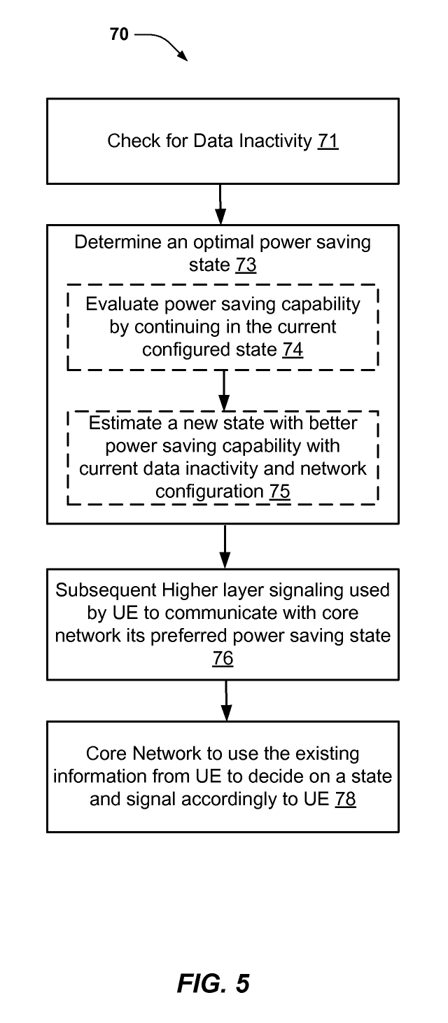

FIG. 5 illustrates an example method 70 of various options for communicating power saving information in a wireless network.

At 71, a check is performed for data inactivity. For example, this may include checking an amount of data to send in a given time period. Indeed, the UE 12 is configured to check for data inactivity and/or the current power saving state of which the UE 12 is currently operating.

At 73, an optimal power saving state can be determined. If the data to send is less than a threshold, or if the data is of low priority, for example, a power state utilizing less resources can be determined. For example, this can include evaluating a power saving capability by continuing in the current configured state at 74, and/or estimating a new state with better power saving capability with current data inactivity and network configuration at 75. Indeed, power saving component 16 residing in UE 12 is configured to determine power saving information 22 related to UE 12 that may be communicated to network component 14 by communicating component 18 (FIG. 1).

At 76, subsequent higher layer signaling can be used by the UE to communicate with core network over its preferred power saving state, and at 78, the core network can use the existing information from UE to decide on a state and signal the state to UE. For example, power saving information 22 may be signaled to network component 14 from UE 12 in a resource update message and the power saving state 30 for operating UE 12 may be determined by the power saving state determining component 28 residing in network component 14 and based on the power saving information 22 received at the network component 14 (FIG. 1).

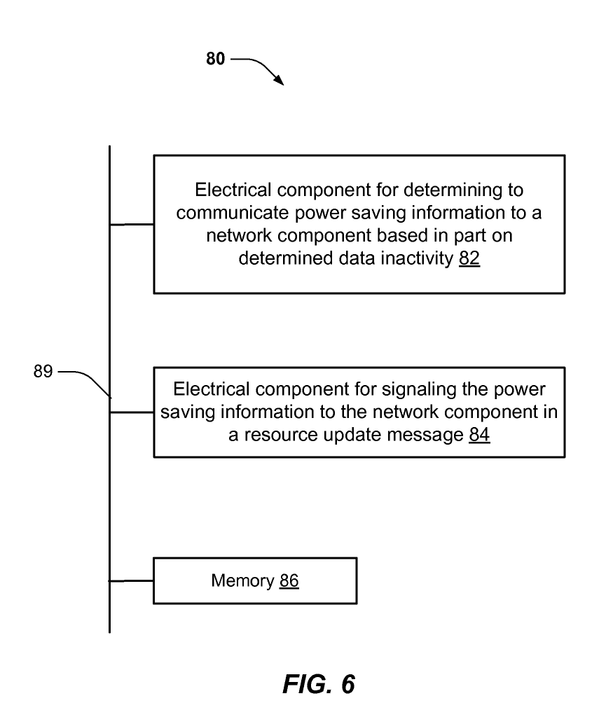

FIG. 6 illustrates an example system 80 for signaling power saving information. For example, system 80 can reside at least partially within a UE. It is to be appreciated that system 80 is represented as including functional blocks, which can be functional blocks that represent functions implemented by a processor, software, or combination thereof (e.g., firmware). System 80 includes an electrical component for determining to communicate power saving information to a network component based in part on determined data inactivity, and an electrical component for signaling the power saving information to the network component in a resource update message. Note, electrical component 82 and 84, respectively, perform the functions of power saving component 16 residing in UE 12 and the communicating component 18 residing in UE 12 (FIG. 1).

Additionally, system 80 can include a memory 86 that retains instructions for executing functions associated with the electrical components 82 and 84. While shown as being external to memory 86, it is to be understood that one or more of the electrical components 82 and 84 can exist within memory 86. Electrical components 82 and 84, in an example, can be interconnected over a bus 89 or similar connection to allow communication among the components. In one example, electrical components 82 and 84 can comprise at least one processor, or each electrical component 82 and 84 can be a corresponding module of at least one processor. Moreover, in an additional or alternative example, electrical components 82 and 84 can be a computer program product comprising a computer readable medium, where each electrical component 82 and 84 can be corresponding code.

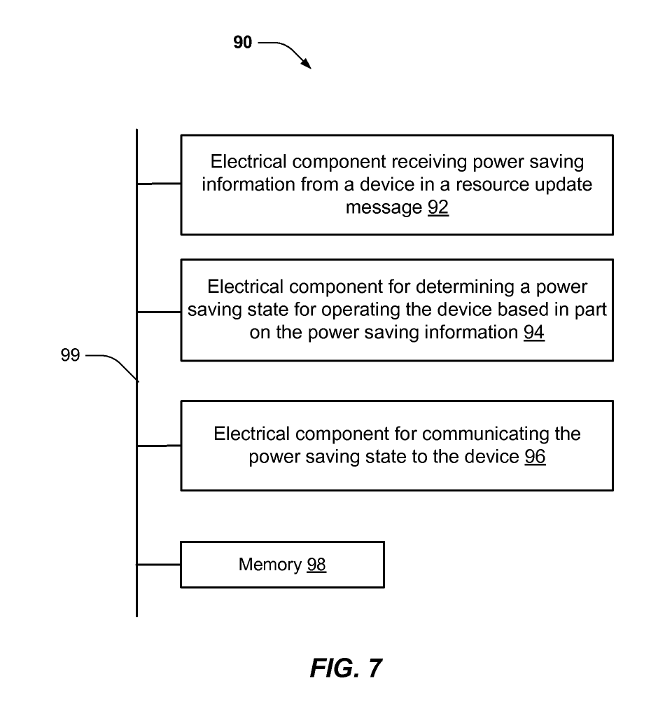

FIG. 7 illustrates an example system 90 for determining a power saving state for a device. For example, system 90 can reside at least partially within a network component. It is to be appreciated that system 90 is represented as including functional blocks, which can be functional blocks that represent functions implemented by a processor, software, or combination thereof (e.g., firmware). System 90 includes an electrical component for receiving power saving information from a device in a resource update message, an electrical component for determining a power saving state for operating the device based in part on the power saving information, and an electrical component for communicating the power saving state to the device. Note, electrical component 92 and 96 perform the functions of communicating component 24 (FIG. 1) and electrical component 94 performs the function of the power saving state determining component 28 (FIG. 1). Additionally, system 90 can include a memory 98 that retains instructions for executing functions associated with the electrical components 92, 94, and 96. While shown as being external to memory 98, it is to be understood that one or more of the electrical components 92, 94, and 96 can exist within memory 98. Electrical components 92, 94, and 96, in an example, can be interconnected over a bus 99 or similar connection to allow communication among the components. In one example, electrical components 92, 94, and 96 can comprise at least one processor, or each electrical component 92, 94, and 96 can be a corresponding module of at least one processor. Moreover, in an additional or alternative example, electrical components 92, 94, and 96 can be a computer program product comprising a computer readable medium, where each electrical component 92, 94, and 96 can be corresponding code.

Referring to FIG. 8, in one aspect, UE 12 or network component 14 may be represented by a specially programmed or configured computer device 350, wherein the special programming or configuration includes call processing component 72, which may be configured to perform the operation of any of the components residing in UE 12 and network component 14, as described herein. For example, for implementation as UE 12 (FIG. 1), computer device 350 may include one or more components for computing and transmitting a RRC signaling message, such as in specially programmed computer readable instructions or code, firmware, hardware, or some combination thereof. In other words, in an implementation such as UE 12 of FIG. 1, call processing component 72 may comprise power saving component 18, communicating component 18 and power saving state operating component 20. Or, for example, in an implementation of a network component such as network component 14 of FIG. 1, call processing component 72 may comprise communicating component 24, power saving information extracting component 26 and power saving state determining component 28. Computer device 350 includes a processor 352 for carrying out processing functions associated with one or more of components and functions described herein. Processor 352 can include a single or multiple set of processors or multi-core processors. Moreover, processor 352 can be implemented as an integrated processing system and/or a distributed processing system.

Computer device 350 further includes a memory 354, such as for storing data used herein and/or local versions of applications being executed by processor 352. Memory 354 can include any type of memory usable by a computer, such as random access memory (RAM), read only memory (ROM), tapes, magnetic discs, optical discs, volatile memory, non-volatile memory, and any combination thereof.

Further, computer device 350 includes a communications component 356 that provides for establishing and maintaining communications with one or more parties utilizing hardware, software, and services as described herein. Communications component 356 may carry communications between components on computer device 350, as well as between computer device 350 and external devices, such as devices located across a communications network and/or devices serially or locally connected to computer device 350. For example, communications component 356 may include one or more buses, and may further include transmit chain components and receive chain components associated with a transmitter and receiver, respectively, or a transceiver, operable for interfacing with external devices. For example, in an aspect, a receiver of communications component 356 operates to receive one or more radio resource control (RRC) messages into a radio link control (RLC) queue, which may be a part of memory 354. Also, for example, in an aspect, a transmitter of communications component 356 operates to transmit, e.g. from the RLC queue, the prioritized one or more RRC messages in order of priority.

Additionally, computer device 350 may further include a data store 358, which can be any suitable combination of hardware and/or software, that provides for mass storage of information, databases, and programs employed in connection with aspects described herein. For example, data store 358 may be a data repository for applications not currently being executed by processor 352.

Computer device 350 may additionally include a user interface component 360 operable to receive inputs from a user of computer device 350, and further operable to generate outputs for presentation to the user. User interface component 360 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 360 may include one or more output devices, including but not limited to a display, a speaker, a haptic feedback mechanism, a printer, any other mechanism capable of presenting an output to a user, or any combination thereof.

Furthermore, computer device 350 may include, or may be in communication with, call processing component 72, which may be configured to perform the functions described herein.

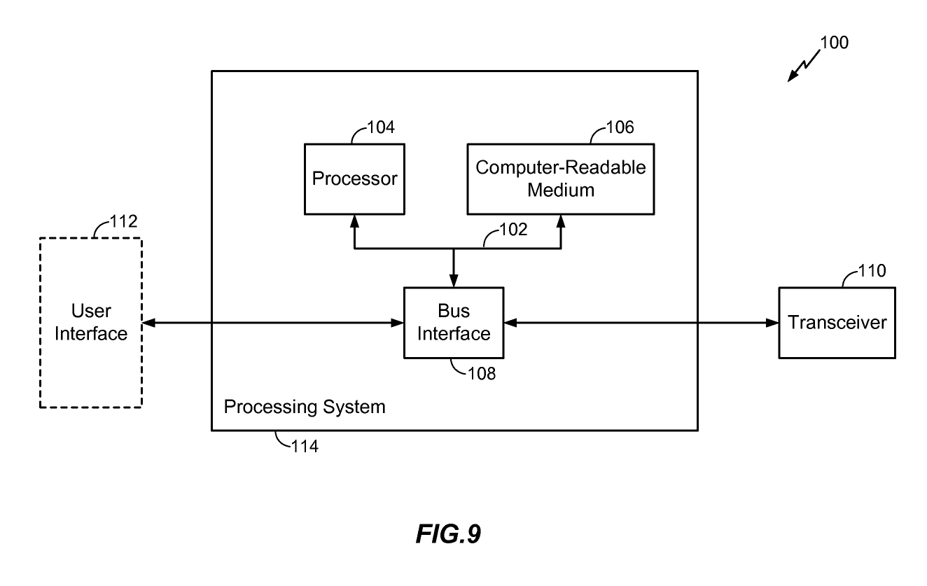

FIG. 9 is a block diagram illustrating an example of a hardware implementation for an apparatus 100 employing a processing system 114. For example, apparatus 100 may be specially programmed or otherwise configured to operate as UE 12 or network component 14, etc., as described above. In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software. In an aspect, for example, processor 104 and/or computer-readable medium 106 may be specially programmed or otherwise configured to operate as UE 12, network component 14, etc., as described above.

The various concepts presented throughout this disclosure may be implemented across a broad variety of telecommunication systems, network architectures, and communication standards.

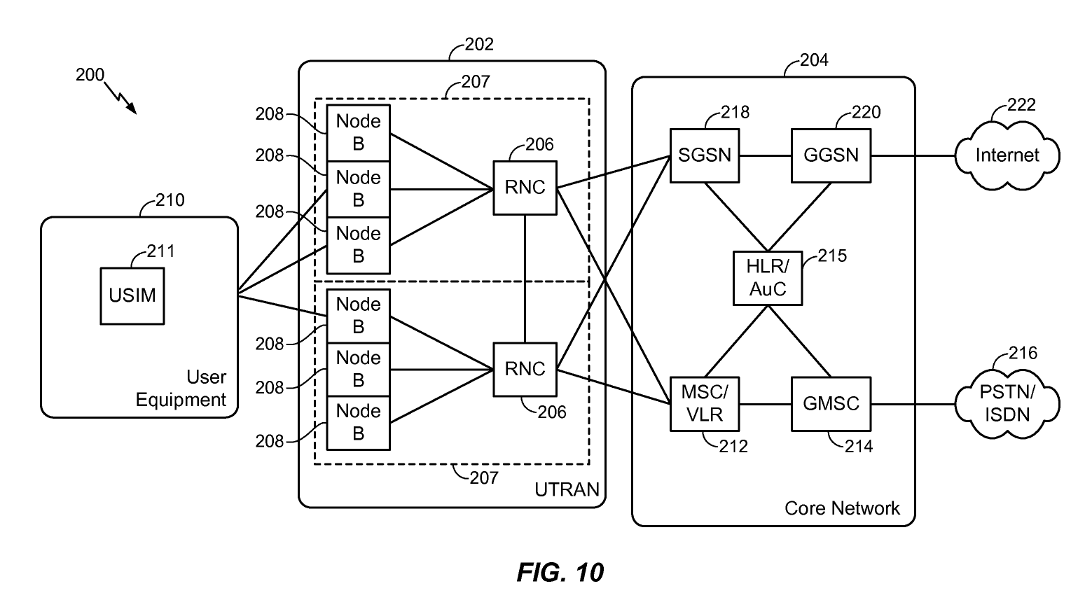

By way of example and without limitation, the aspects of the present disclosure illustrated in FIG. 10 are presented with reference to a UMTS system 200 employing a W-CDMA air interface. A UMTS network includes three interacting domains: a Core Network (CN) 204, a UMTS Terrestrial Radio Access Network (UTRAN) 202, and User Equipment (UE) 210. In this example, the UTRAN 202 provides various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the RNCs 206 and RNSs 207 illustrated herein. The RNC 206 is an apparatus responsible for, among other things, assigning, reconfiguring and releasing radio resources within the RNS 207. The RNC 206 may be interconnected to other RNCs (not shown) in the UTRAN 202 through various types of interfaces such as a direct physical connection, a virtual network, or the like, using any suitable transport network.

Communication between a UE 210 and a Node B 208 may be considered as including a physical (PHY) layer and a medium access control (MAC) layer. Further, communication between a UE 210 and an RNC 206 by way of a respective Node B 208 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in the RRC Protocol Specification, 3GPP TS 25.331 v9.1.0, incorporated herein by reference. Further, for example, UE 210 may be specially programmed or otherwise configured to operate as UE 12, and/or Node B 208 as network component 14, as described above.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each RNS 207; however, the RNSs 207 may include any number of wireless Node Bs. The Node Bs 208 provide wireless access points to a CN 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The DL, also called the forward link, refers to the communication link from a Node B 208 to a UE 210, and the UL, also called the reverse link, refers to the communication link from a UE 210 to a Node B 208.

The CN 204 interfaces with one or more access networks, such as the UTRAN 202. As shown, the CN 204 is a GSM core network. However, as those skilled in the art will recognize, the various concepts presented throughout this disclosure may be implemented in a RAN, or other suitable access network, to provide UEs with access to types of CNs other than GSM networks.

The CN 204 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a VLR that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The CN 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 208 and a UE 210. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 210 provides feedback to the node B 208 over the HS-DPCCH to indicate whether it correctly decoded a packet on the downlink.

HS-DPCCH further includes feedback signaling from the UE 210 to assist the node B 208 in taking the right decision in terms of modulation and coding scheme and precoding weight selection, this feedback signaling including the CQI and PCI.

“HSPA Evolved” or HSPA+ is an evolution of the HSPA standard that includes MIMO and 64-QAM, enabling increased throughput and higher performance. That is, in an aspect of the disclosure, the node B 208 and/or the UE 210 may have multiple antennas supporting MIMO technology. The use of MIMO technology enables the node B 208 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 210 to increase the data rate or to multiple UEs 210 to increase the overall system capacity. This is achieved by spatially precoding each data stream and then transmitting each spatially precoded stream through a different transmit antenna on the downlink. The spatially precoded data streams arrive at the UE(s) 210 with different spatial signatures, which enables each of the UE(s) 210 to recover the one or more the data streams destined for that UE 210. On the uplink, each UE 210 may transmit one or more spatially precoded data streams, which enables the node B 208 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

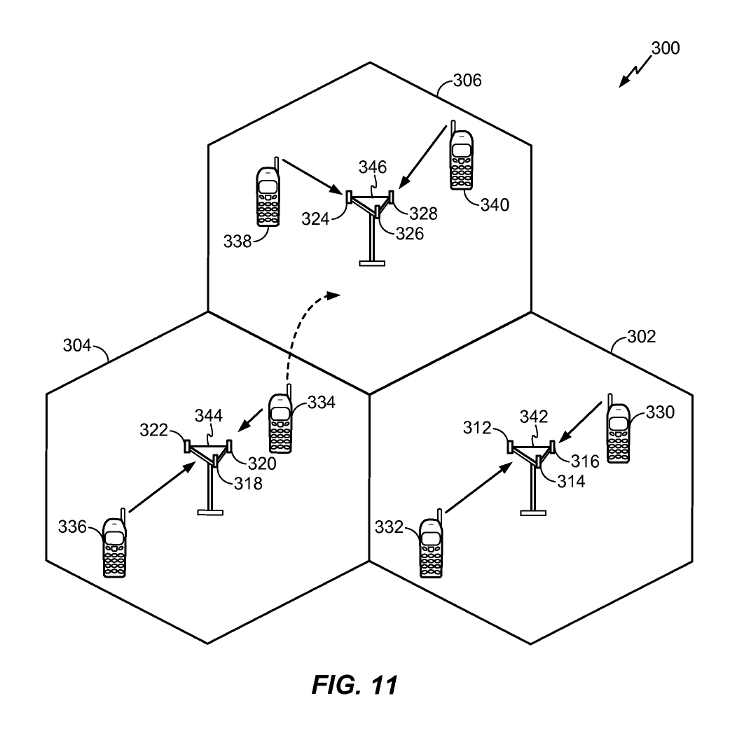

Referring to FIG. 11, an access network 300 in a UTRAN architecture is illustrated. The multiple access wireless communication system includes multiple cellular regions (cells), including cells 302, 304, and 306, each of which may include one or more sectors. The multiple sectors can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 each correspond to a different sector. In cell 306, antenna groups 324, 326, and 328 each correspond to a different sector. The cells 302, 304 and 306 may include several wireless communication devices, e.g., User Equipment or UEs, which may be in communication with one or more sectors of each cell 302, 304 or 306. For example, UEs 330 and 332 may be in communication with Node B 342, UEs 334 and 336 may be in communication with Node B 344, and UEs 338 and 340 can be in communication with Node B 346. Here, each Node B 342, 344, 346 is configured to provide an access point to a CN 204 (see FIG. 9) for all the UEs 330, 332, 334, 336, 338, 340 in the respective cells 302, 304, and 306. For example, in an aspect, the UEs of FIG. 10 may be specially programmed or otherwise configured to operate as UE 12, and/or Node Bs as network component 14, as described above.

As the UE 334 moves from the illustrated location in cell 304 into cell 306, a serving cell change (SCC) or handover may occur in which communication with the UE 334 transitions from the cell 304, which may be referred to as the source cell, to cell 306, which may be referred to as the target cell. Management of the handover procedure may take place at the UE 334, at the Node Bs corresponding to the respective cells, at a radio network controller 206 (see FIG. 9), or at another suitable node in the wireless network. For example, during a call with the source cell 304, or at any other time, the UE 334 may monitor various parameters of the source cell 304 as well as various parameters of neighboring cells such as cells 306 and 302. Further, depending on the quality of these parameters, the UE 334 may maintain communication with one or more of the neighboring cells. During this time, the UE 334 may maintain an Active Set, that is, a list of cells that the UE 334 is simultaneously connected to (i.e., the UTRA cells that are currently assigning a downlink dedicated physical channel DPCH or fractional downlink dedicated physical channel F-DPCH to the UE 334 may constitute the Active Set).

The modulation and multiple access scheme employed by the access network 300 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA, and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE CDMA2000 and UMB are described in documents from the 3GPP2 organization. The actual wireless communication standard and the multiple access technology employed will depend on the specific application and the overall design constraints imposed on the system.

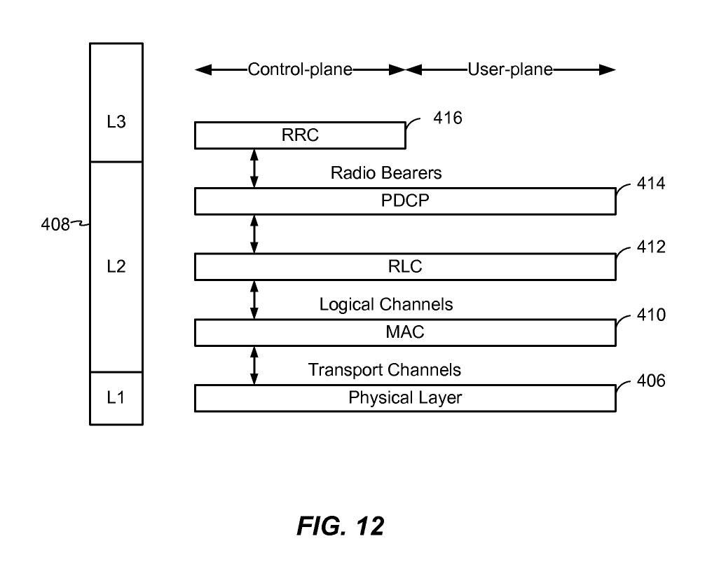

The radio protocol architecture may take on various forms depending on the particular application. An example for an HSPA system will now be presented with reference to FIG. 12. FIG. 12 is a conceptual diagram illustrating an example of the radio protocol architecture for the user and control planes.

Referring to FIG. 12, the radio protocol architecture for the UE and Node B is shown with three layers: Layer 1, Layer 2, and Layer 3. Layer 1 is the lowest lower and implements various physical layer signal processing functions. Layer 1 will be referred to herein as the physical layer 406. Layer 2 (L2 layer) 408 is above the physical layer 406 and is responsible for the link between the UE and Node B over the physical layer 406. For example, the UE corresponding to the radio protocol architecture of FIG. 11 may be specially programmed or otherwise configured to operate as UE 12, network component 14, etc., as described above.

In the user plane, the L2 layer 408 includes a media access control (MAC) sublayer 410, a radio link control (RLC) sublayer 412, and a packet data convergence protocol (PDCP) 414 sublayer, which are terminated at the node B on the network side. Although not shown, the UE may have several upper layers above the L2 layer 408 including a network layer (e.g., IP layer) that is terminated at a PDN gateway on the network side, and an application layer that is terminated at the other end of the connection (e.g., far end UE, server, etc.).

The PDCP sublayer 414 provides multiplexing between different radio bearers and logical channels. The PDCP sublayer 414 also provides header compression for upper layer data packets to reduce radio transmission overhead, security by ciphering the data packets, and handover support for UEs between node Bs. The RLC sublayer 412 provides segmentation and reassembly of upper layer data packets, retransmission of lost data packets, and reordering of data packets to compensate for out-of-order reception due to hybrid automatic repeat request (HARQ). The MAC sublayer 410 provides multiplexing between logical and transport channels. The MAC sublayer 410 is also responsible for allocating the various radio resources (e.g., resource blocks) in one cell among the UEs. The MAC sublayer 410 is also responsible for HARQ operations.

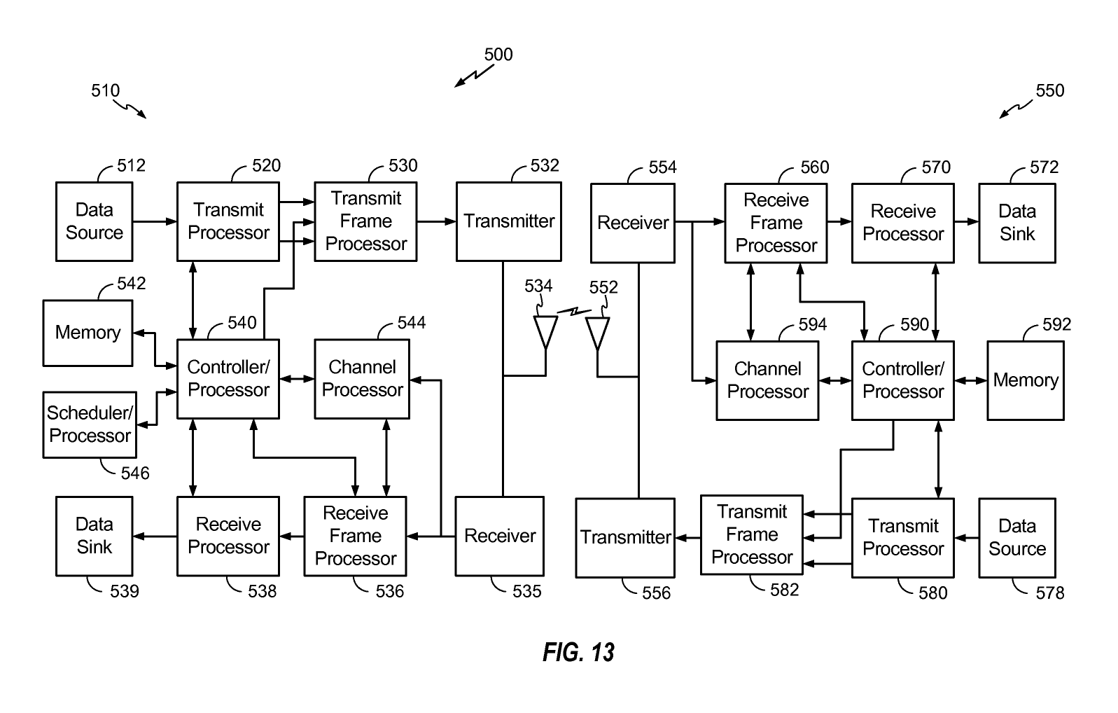

FIG. 13 is a block diagram of a system 500 including a Node B 510 in communication with a UE 550. For example, UE 550 may be specially programmed or otherwise configured to operate as UE 12, and/or Node B 510 as network component 14, as described above. Further, for example, the Node B 510 may be the Node B 208 in FIG. 10, and the UE 550 may be the UE 210 in FIG. 10. In the downlink communication, a transmit processor 520 may receive data from a data source 512 and control signals from a controller/processor 540. The transmit processor 520 provides various signal processing functions for the data and control signals, as well as reference signals (e.g., pilot signals). For example, the transmit processor 520 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 544 may be used by a controller/processor 540 to determine the coding, modulation, spreading, and/or scrambling schemes for the transmit processor 520. These channel estimates may be derived from a reference signal transmitted by the UE 550 or from feedback from the UE 550. The symbols generated by the transmit processor 520 are provided to a transmit frame processor 530 to create a frame structure. The transmit frame processor 530 creates this frame structure by multiplexing the symbols with information from the controller/processor 540, resulting in a series of frames. The frames are then provided to a transmitter 532, which provides various signal conditioning functions including amplifying, filtering, and modulating the frames onto a carrier for downlink transmission over the wireless medium through antenna 534. The antenna 534 may include one or more antennas, for example, including beam steering bidirectional adaptive antenna arrays or other similar beam technologies.

At the UE 550, a receiver 554 receives the downlink transmission through an antenna 552 and processes the transmission to recover the information modulated onto the carrier. The information recovered by the receiver 554 is provided to a receive frame processor 560, which parses each frame, and provides information from the frames to a channel processor 594 and the data, control, and reference signals to a receive processor 570. The receive processor 570 then performs the inverse of the processing performed by the transmit processor 520 in the Node B 510. More specifically, the receive processor 570 descrambles and despreads the symbols, and then determines the most likely signal constellation points transmitted by the Node B 510 based on the modulation scheme. These soft decisions may be based on channel estimates computed by the channel processor 594. The soft decisions are then decoded and deinterleaved to recover the data, control, and reference signals. The CRC codes are then checked to determine whether the frames were successfully decoded. The data carried by the successfully decoded frames will then be provided to a data sink 572, which represents applications running in the UE 550 and/or various user interfaces (e.g., display). Control signals carried by successfully decoded frames will be provided to a controller/processor 590. When frames are unsuccessfully decoded by the receiver processor 570, the controller/processor 590 may also use an acknowledgement (ACK) and/or negative acknowledgement (NACK) protocol to support retransmission requests for those frames.

In the uplink, data from a data source 578 and control signals from the controller/processor 590 are provided to a transmit processor 580. The data source 578 may represent applications running in the UE 550 and various user interfaces (e.g., keyboard). Similar to the functionality described in connection with the downlink transmission by the Node B 510, the transmit processor 580 provides various signal processing functions including CRC codes, coding and interleaving to facilitate FEC, mapping to signal constellations, spreading with OVSFs, and scrambling to produce a series of symbols. Channel estimates, derived by the channel processor 594 from a reference signal transmitted by the Node B 510 or from feedback contained in the midamble transmitted by the Node B 510, may be used to select the appropriate coding, modulation, spreading, and/or scrambling schemes. The symbols produced by the transmit processor 580 will be provided to a transmit frame processor 582 to create a frame structure. The transmit frame processor 582 creates this frame structure by multiplexing the symbols with information from the controller/processor 590, resulting in a series of frames. The frames are then provided to a transmitter 556, which provides various signal conditioning functions including amplification, filtering, and modulating the frames onto a carrier for uplink transmission over the wireless medium through the antenna 552.

The uplink transmission is processed at the Node B 510 in a manner similar to that described in connection with the receiver function at the UE 550. A receiver 535 receives the uplink transmission through the antenna 534 and processes the transmission to recover the information modulated onto the carrier. The information recovered by the receiver 535 is provided to a receive frame processor 536, which parses each frame, and provides information from the frames to the channel processor 544 and the data, control, and reference signals to a receive processor 538. The receive processor 538 performs the inverse of the processing performed by the transmit processor 580 in the UE 550. The data and control signals carried by the successfully decoded frames may then be provided to a data sink 539 and the controller/processor, respectively. If some of the frames were unsuccessfully decoded by the receive processor, the controller/processor 540 may also use an acknowledgement (ACK) and/or negative acknowledgement (NACK) protocol to support retransmission requests for those frames.

The controller/processors 540 and 590 may be used to direct the operation at the Node B 510 and the UE 550, respectively. For example, the controller/processors 540 and 590 may provide various functions including timing, peripheral interfaces, voltage regulation, power management, and other control functions. The computer readable media of memories 542 and 592 may store data and software for the Node B 510 and the UE 550, respectively. A scheduler/processor 546 at the Node B 510 may be used to allocate resources to the UEs and schedule downlink and/or uplink transmissions for the UEs.

In an aspect, Appendix A describes examples for communicating power saving information in common uplink messages.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.”

Further, unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” rget Node B to refrain from assigning resources to the UE.

What is claimed is:

1. A method for communicating power saving information in a wireless network, comprising:
determining to communicate power saving information to a network component based in part on determined data inactivity; and
signaling the power saving information to the network component in a resource update message.

2. The method of claim 1, further comprising receiving a power saving state from the network component, and operating in the power saving state.

3. The method of claim 1, wherein the resource update message is a CELL_UPDATE message or a Universal Mobile Telecommunications System Terrestrial Radio Access Network Registration Area (URA)_UPDATE message.

4. The method of claim 1, further comprising determining to request transitioning to a power saving state based in part on a comparison of a current state with the power saving state, wherein the power saving information is based in part on the power saving state.

5. The method of claim 4, wherein the comparison of the current state with the power saving state includes determining whether the power saving state would meet certain data requirements.

6. The method of claim 1, further comprising:
detecting that data a user equipment (UE) has to send to the network is less than a predetermined threshold;
generating the power saving information based on detecting that data the UE has to send to the network is less than a predetermined threshold.

7. The method of claim 1, wherein the power saving information includes a request to transition to a state using less power.

8. The method of claim 1, wherein the power saving information includes a request to terminate a data connection.

9. An apparatus for communicating power saving information in a wireless network, comprising:
at least one processor configured to:
determine to communicate power saving information to a network component based in part on determined data inactivity; and
signal the power saving information to the network component in a resource update message; and
a memory coupled to the at least one processor.

10. The apparatus of claim 9, wherein the at least one processor is further configured to receive a power saving state from the network component, and operate in the power saving state.

11. The apparatus of claim 9, wherein the resource update message is a CELL_UPDATE message or a Universal Mobile Telecommunications System Terrestrial Radio Access Network Registration Area (URA)_UPDATE message.

12. The apparatus of claim 9, wherein the at least one processor is further configured to determine to request transitioning to a power saving state based in part on a comparison of a current state with the power saving state, wherein the power saving information is based in part on the power saving state.

13. The apparatus of claim 12, wherein the at least one processor configured to compare the current state with the power saving state is further configured to determine whether the power saving state would meet certain data requirements.

14. The apparatus of claim 9, wherein the at least on processor configured to:
detect that data a UE has to send to the network is less than a predetermined threshold;
generate the power saving information based on the detection that data the UE has to send to the network is less than a predetermined threshold.

15. The apparatus of claim 9, wherein the power saving information includes a request to transition to a state using less power.

16. The apparatus of claim 9 wherein the power saving information includes a request to terminate a data connection.

17. An apparatus for communicating power saving information in a wireless network, comprising:
means for determining to communicate power saving information to a network component based in part on determined data inactivity; and
means for signaling the power saving information to the network component in a resource update message.

18. The apparatus of claim 17, further comprising means for receiving a power saving state from the network component, and means for operating in the power saving state.

19. The apparatus of claim 17, wherein the resource update message is a CELL_UPDATE message or a Universal Mobile Telecommunications System Terrestrial Radio Access Network Registration Area (URA)_UPDATE message.

20. The apparatus of claim 17, further comprising means for determining to request transitioning to a power saving state based in part on a comparison of a current state with the power saving state, wherein the power saving information is based in part on the power saving state.

21. The apparatus of claim 20, wherein the comparison of the current state with the power saving state includes means for determining whether the power saving sate would meet certain data requirements.

22. The apparatus of claim 17, further comprising:
means for detecting that data a UE has to send to the network is less than a predetermined threshold;
means for generating the power saving information based on detecting that data the UE has to send to the network is less than a predetermined threshold.

23. The apparatus of claim 17, wherein the power saving information includes a request to transition to a state using less power.

24. The apparatus of claim 17, wherein the power saving information includes a request to terminate a data connection.

25. A computer program product for communicating power saving information in a wireless network, comprising:
a computer-readable medium, comprising:
code for causing at least one computer to determine to communicate power saving information to a network component based in part on determined data inactivity; and
code for causing the at least one computer to signal the power saving information to the network component in a resource update message.

26. A method for communicating power saving information in a wireless network, comprising:
receiving power saving information from a device in a resource update message;
determining a power saving state for operating the device based in part on the power saving information; and
communicating the power saving state to the device.

27. The method of claim 26, wherein the determining the power saving state comprises:
determining a new power saving state that uses less power than a current power saving state operated by the device.

28. The method of claim 26, wherein the resource update message is a CELL_UPDATE message or a Universal Mobile Telecommunications System Terrestrial Radio Access Network Registration Area (URA)_UPDATE message.

29. The method of claim 26, further comprising commanding the device to release radio resources based in part on the power saving information.

30. The method of claim 26, wherein the power saving information includes a request to transition to a state using less power.

31. The method of claim 26, wherein the power saving information includes a request to terminate a data connection.

32. The method of claim 26, wherein determining the power saving state meets certain data requirements.

33. An apparatus for communicating power saving information in a wireless network, comprising:
at least one processor configured to:
receive power saving information from a device in a resource update message;
determine a power saving state for operating the device based in part on the power saving information; and
communicate the power saving state to the device; and
a memory coupled to the at least one processor.

34. The apparatus of claim 33, wherein the at least one processor configured to determine the power saving state is further configured:
for determining a new power saving state that uses less power than a current power saving state operated by the device.

35. The apparatus of claim 33, wherein the resource update message is a CELL_UPDATE message or a Universal Mobile Telecommunications System Terrestrial Radio Access Network Registration Area (URA)_UPDATE message.

36. The apparatus of claim 33, wherein the at least one processor is further configured to command the device to release radio resources based in part on the power saving information.

37. The apparatus of claim 33, wherein the power saving information includes a request to transition to a state using less power.

38. The apparatus of claim 33, wherein the power saving information includes a request to terminate a data connection.

39. The apparatus of claim 33, wherein the at least one processor is further configured to determine the power saving state meets certain data requirements.

40. An apparatus for communicating power saving information in a wireless network, comprising:
means for receiving power saving information from a device in a resource update message;
means for determining a power saving state for operating the device based in part on the power saving information; and
means for communicating the power saving state to the device.

41. The apparatus of claim 40, wherein the means for determining the power saving state further comprises:
means for determining a new power saving state that uses less power than a current power saving state operated by the device.

42. The apparatus of claim 40, wherein the resource update message is a CELL_UPDATE message or a Universal Mobile Telecommunications System Terrestrial Radio Access Network Registration Area (URA)_UPDATE message.

43. The apparatus of claim 40, further comprising commanding the device to release radio resources based in part on the power saving information.

44. The apparatus of claim 40, wherein the power saving information includes a request to transition to a state using less power.

45. The apparatus of claim 40, wherein the power saving information includes a request to terminate a data connection.

46. The apparatus of claim 40, wherein determining the power saving state meets certain data requirements

47. A computer program product for communicating power saving information in a wireless network, comprising:
a computer-readable medium, comprising:
code for causing at least one computer to receive power saving information from a device in a resource update message;
code for causing the at least one computer to determine a power saving state for operating the device based in part on the power saving information; and
code for causing the at least one computer to communicate the power saving state to the device.
